(19) United States
(12) Patent Application Publication
(10) Pub. No.: US 2005/0247639 A1
(43) Pub. Date: Nov. 10, 2005

(54) Reduction in biological oxygen demand levels in waste water effluents

(76) Inventors: Bud G. Harmon, Chesterfield, MO (US); Timothy M. Ortman, Carmel, IN (US)

Correspondence Address: GREENLEE WINNER AND SULLIVAN P C, 4875 PEARL EAST CIRCLE, SUITE 200, BOULDER, CO, 80301, US

(21) Appl. No.: 10/511,891

(22) PCT Filed: Apr. 23, 2003
(86) PCT No.: PCT/US03/12760

§ 371 Date: Jun. 9, 2005

(30) Foreign Application Priority Data
Apr. 23, 2002 (US) 60375213

(51) Int. Cl. C02F 1/24

(52) U.S. Cl. 210/703

(57) ABSTRACT

The aeration process of the present invention reduces the biological oxygen demand of aqueous waste streams including those from animal meat processing facilities, vegetable or fruit processing facilities, fermentation processes and certain organic chemical processes. Magnesium chloride is used at a concentration of from about 0.02% to about 3.0% (w/v) and all ranges and concentrations therebetween, desirably from about 0.02% to about 0.5% (w/v), and aeration is carried out at a rate sufficient to maintain a dissolved oxygen level of from about 1 to about 8 ppm for to about seven days, usually one to seven days. Desirably, especially for animal meat processing waste streams, a dissolved air flocculation step precedes the aeration for (further) reduction of biological demand, and preferably the dissolved air flocculation step is carried out with a magnesium salt.

### CROSS REFERENCE TO RELATED APPLICATIONS

This application claims priority from U.S. Provisional Application Ser. No. 60/375,213, filed Apr. 23, 2002.

### BACKGROUND OF THE INVENTION

The field of this invention is waste treatment, especially reducing the biological oxygen demand (BOD) in waste streams such as those from food processing plants, especially animal processing facilities, municipal waste treatment facilities, or effluents from fermentation or chemical plants. Specifically, magnesium enriched wastewater is aerated for a time and under conditions such that BOD is reduced, desirably below 500, and especially to below about 50 ppm.

Meat processing plants generate significant amounts of solid organic waste material daily and that waste can be difficult and expensive to treat. Meat processing wastes typically contain blood, fat, muscle, bone and viscera, mixed in large quantities of water. That waste effluent could potentially contaminate water supplies if not properly treated to remove the material in it. State and federal regulations require that dissolved solids, chemical oxygen demand (COD), biological oxygen demand (BOD) and total organic carbon (TOC) of water discharged into sewers, rivers or municipal wastewater treatment plants meet standards designed to protect the public and the environment.

The most commonly used waste treatment systems for food processing plants involve either using anaerobic lagoons with extremely malodorous degradation of organic matter or pumping the waste stream through a dissolved air flotation (DAF) system. The organic solids captured from a DAF system do not necessarily have to be deposited in landfills, which is a costly process as well as an environmental burden. Absent toxic chemicals, certain isolated organic solids can be used in the formulation of animal feeds. Realizing a use for removed solids provides economic benefit in terms of providing a salable product as well as the savings of hauling material and paying landfill fees.

Ferric chloride has been the primary flocculent used in DAF systems because it is economical, widely available, and greatly enhances the separation of liquids from solids. Although ferric chloride is efficient in removing organic solids, it destroys most nutritional value of the isolated solids and discolors the fat within the solids. Most animals will refuse to eat feed containing significant amounts of ferric chloride. As a result, isolated solids high in ferric chloride are typically deposited in landfills. In addition, ferric chloride severely oxidizes metal components of DAF systems.

The magnesium chloride/aluminum chloride flocculent described in U.S. Pat. No. 6,235,339 B1 (Harmon and Barlow, 2001) captures organic solids without the highly oxidative and corrosive effects of ferric chloride on organic matter and equipment. Although replacing ferric chloride with the magnesiumchloride/aluminum chloride flocculent allows the recovered solid waste to be used as a commercial product and significantly reduces the BOD of the treated waste material, there remains an economic and environmental need to further reduce the BOD of the effluent waste after flocculation, especially below the maximum allowable levels required by government regulations.

There is a general need to reduce BOD levels in waste water from sources including, but not limited to, meat processing plants, vegetable and fruit processing plants, organic chemical plants, fermentation facilities and municipal waste treatment plants. The present invention addresses these needs.

### SUMMARY OF THE INVENTION

The present invention provides methods for reducing the biological oxygen demand in a waste product stream (or a post-flocculation waste stream) through aeration of magnesium enriched effluents. During aeration, magnesium acts as an oxidizing catalyst and accelerates reduction of BOD levels. Such aprocess can beused when magnesium chloride is added directly to a waste stream during or before aeration, or for the effluent remaining after using a magnesium chloride flocculent in a DAF system. The waste stream can contain plant or animal matter or fermentation waste material. Of particular interest are those waste streams derived from food animal processing facilities, which contained blood, fine bone, fat, and the like prior to the flocculation step, fruit and vegetable processing waste water, fermentation waste water, and in at least some cases, effluents from organic chemical plants containing waste water. Chemical oxygen demand (COD) can also be reduced by this process. Magnesium is incorporated in the effluentor waste stream at a concentration from about 0.02% to 3.0%, and all concentrations and ranges of concentration therebetween, and desirably 0.02 to about 0.5% final concentration, (weight/volume MgCl₂) when magnesium chloride is used. Other magnesium salts can be used, with the proviso that an equivalent concentration of magnesium cation is incorporated in the waste. Aeration is accomplished by any means known to the art to deliver oxygen at a rate sufficient to maintain dissolved oxygen levels from about 1 to about 8 ppm, and aeration is extended up to at least about 24 hours, and up to about 7 days, depending on the BOD in the starting effluent and the nature of the BOD.

After removing the organic solids following treatment in the DAF system, the normal procedure is to discharge the effluent to the municipal or other waste treatment plant for further processing. If a magnesium chloride flocculent is used, the magnesium remains mainly in the liquid of the final effluent after removal of flocculated material. The BOD levels at this point can be 800 ppm or less depending on the characteristics of the processing plant. Extended aeration of the effluent will result in reduced BOD levels. For comparison, aeration for 24 hours or greater with magnesium enriched effluent is more efficient in reducing BOD than aeration with ferric chloride for the same time span. Aeration with magnesium obviates the need for oxidizing agents such as sodium hypochlorite or hydrogen peroxide.

The process of the present invention can utilize aeration by means of a Venturi apparatus. Such aeration of the magnesium-enriched waste water or effluent, desirably after a flocculation step with removal of flocculated material, results in foam formation, with a significant amount of the protein and other organic matter in the waster water or effluent migrating into the foams. This process has been termed adsorptive foam separation and foam fractionation. The process is most well known in connection with marine aquaria and marine culture systems. Foam is created when air, water and salts are mixed together. Proteins and other organic compounds coat the air bubbles as they rise through the water, and a relatively stable foam results. Removal of the foam also results in removal of those proteins and other organics trapped within the foam. It is known that small bubbles provide better results than larger bubbles. Protein foam skimmers are known to the art. Without wishing to be bound by any particular theory, it is believed that the magnesiumin the post-flocculation waste water or effluent contributes to the production of stable foams comprising protein and other organics. In waste water or effluents which are not appropriate for treatment with a flocculation process (where there is little or no biosolid material), the aqueous system can be enriched with magnesium cations, especially using MgCl₂, to a concentration of about 100 to about 400 ppm magnesium and subjected to an aeration process as described herein. Venturi systems are especially efficient means of aeration to produce bubbling effective for foaming and reduction of BOD. An advantage of the foam/foam removal systems is that shorter aeration times and/or smaller tanks are possible due to the dramatically improved efficiency with respect to removal of organics and reduction of BOD in the waster water. The shorter time and smaller volumes lead to dramatic improvements in the economics of the waste water treatment.

### BRIEF DESCRIPTION OF THE DRAWINGS

FIGS. 1A and 1B show the reduction in BOD over time with continuous aeration in MgCl₂-treated and FeCl₃-treated waste water (after dissolved air flotation and removal of flocculated material) from a pork processing facility.

FIG. 2A graphically illustrates the drop in BOD over 9 cycles of foam fractionation with continuous aeration supplied by a Venturi apparatus using MgCl₂ and FeCl₃. FIG. 2B shows the results of the same experiment, with the results plotted as percent decrease in BOD over the 9 cycles.

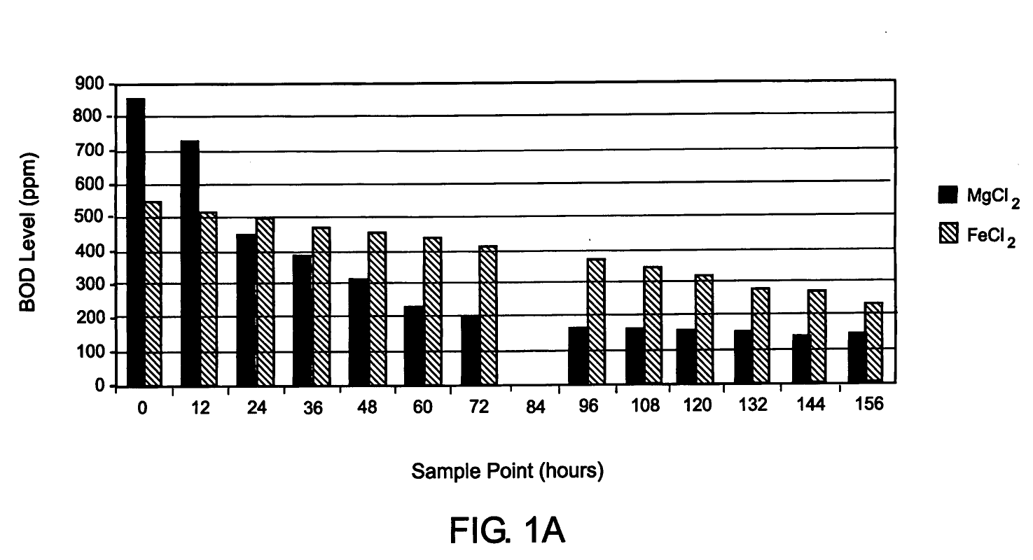

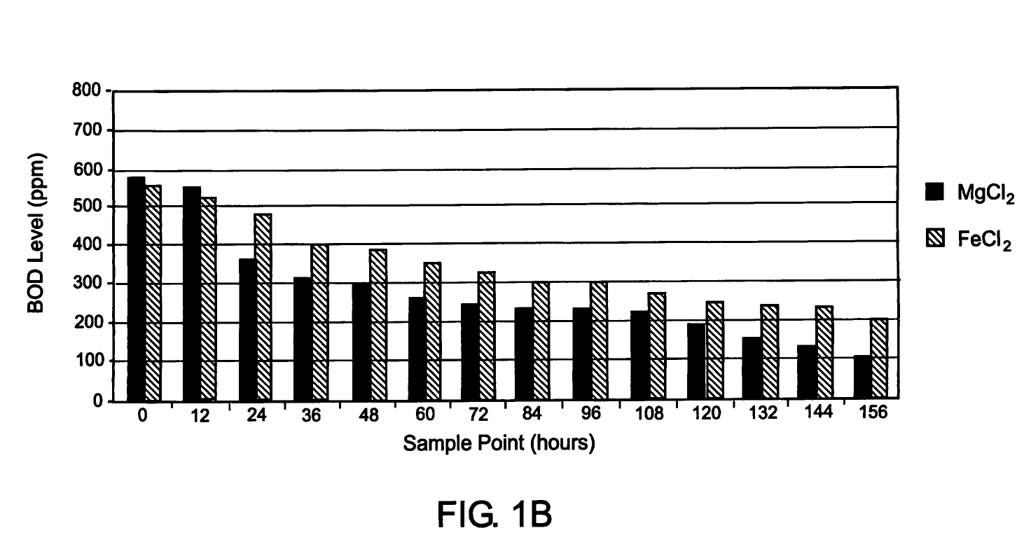

### DETAILED DESCRIPTION OF THE INVENTION

In a typical embodiment, the BOD and COD of a waste stream is reduced by adding divalent magnesium prior to extended aeration. The magnesium can be easily added as technical grade MgCl₂ solution (32% weight/volume). Sufficient MgCl₂ is added to provide between about 0.02%-3.0% MgCl₂ and all concentrations and ranges therebetween, (w/v) solution (or about 0.02% to about 0.5% MgCl₂, final concentration weight/volume in solution) by volume of waste material. Other concentrated MgCl₂ solutions or other magnesium salts may be used. Following the addition of magnesium, aeration, with the dissolved oxygen levels ranging from to 8 ppm is performed as is known in the art. Aeration for large volumes can be accomplished through paddlewheels, bubbling air through the wastewater, water jets, and pumps. (U.S. Pat. Nos. 3,490,752; 3,664,647; 3,984,323; 4,072,612; 6,344,144.) The time of aeration depends on the beginning BOD and COD levels of the effluent to be treated and the desired final levels. This can be determined without undue experimentation.

In a preferred embodiment of this invention, aeration of effluents is used in conjunction with a DAF system utilizing magnesium chloride as the flocculent as described in U.S. Pat. No. 6,235,339, thus allowing a waste treatment process to benefit from a magnesium chloride flocculent while reducing the BOD of the waste stream without the use of additional chemicals. It will nevertheless be understood that no limitation of the scope of the invention is thereby intended, such alterations and further modifications of the invention, and such further applications of the principles of the invention as illustrated herein, being contemplated as would normally occur to one ordinarily skilled in the art.

Desirably, the flocculation step utilizes a soluble magnesium salt which is dissolved in the waste stream. The magnesium salt, preferably magnesium chloride, is added in an amount sufficient to induce the flocculation of organic materials. As described in U.S. Pat. No. 6,235,339, between 1 L to 10 L technical grade MgCl₂ solution (about 32% weight/volume) per 1000 L of the waste stream or effluent. Advantageously, 2 L to 4 L of the 32% MgCl₂ solution per 1000 L effluent is added. In certain applications, small amounts of an aluminum compound are also added. Many aluminum salts can be used, including but not limited to, aluminum chloride, alum, aluminum chlorohydrate, sulfonated PAC (aluminum chloride acrylamide), and aluminum sulfate. The aluminum salt is added from about 0 to 0.5 L of aluminum solution (50% weight/volume) per 1000 L waste effluent or waste water.

Flocculation and solids removal are performed as essentially described in U.S. Pat. No. 6,235,339. That patent reports that after removal of flocculated material, the remaining effluent contains about 800 ppm BOD or less, depending on the type of waste stream which was treated. Total dissolved solids are typically below 60-100 mg per 100 ml. As a result of this process, phosphorus and aluminum are effectively removed with the bio-solids and do not remain in the liquid effluent. Magnesium, however, primarily remains in the liquid effluent.

To lower BOD and COD in the effluent after removal of flocculated material, U.S. Pat. No. 6,235,339 reports adding oxidizing agents, such as 5.25% sodium hypochlorite solution or 3.0% hydrogen peroxide solution. In the present invention, extended aeration, for a time period of one day to seven days and at a rate sufficient to maintain dissolved oxygen levels from about 1 to about 8 ppm, of the magnesium enriched effluent reduces BOD levels to well within acceptable ranges for forwarding the liquid stream on to municipal plants. Flocculation and removal of solids can be carried out prior to the aeration, or in the case of a wastewater stream which did not contain material which could be removed in a flocculation process, aeration of a magnesium enriched effluent, containing from about 100 to about 400 ppm divalent Mg, can reduce BOD to acceptable levels. Any means known to the art can be used to aerate the magnesium-enriched waste water, including, but not limited to, bubblers, fountains, waterfalls, mixing or Venturi systems.

Although use of FeCl₃ in a DAF system linked to extended aeration results in lower BOD levels immediately after flocculation, aeration of a magnesium rich effluent for a time period of 24 hours or more reduces BOD levels lower than attainable in the same system where FeCl₃ is the flocculent. In this example, the liquid effluent from a pork processing plant, aeration of the magnesium rich effluent after flocculation reduced the BOD from approximately 750 ppm to under 400 ppm in 24 hours. By comparison, the same system using FeCl₃ as the flocculent reduced the BOD from 550 ppm to 500 ppm after 24 hours of aeration. Further aeration of the magnesium enriched effluent reduced the BOD to about 100 ppm in 144 hours (6 days).

In another experiment, the primary foam fractionation equipment components were as follows: 1) a protein skimmer, i.e., a foam/water separation vessel, a motor/pump assemblage, a venturi tube w/ air injection port, two five gallon liquid storage containers, and an assortment of piping, tubes, hoses, and valves to connect the primary components into a re-circulation system.

The protein skimmer consists of a clear, plastic cylindrical tube standing on edge with the base secured and sealed to a circular plastic base plate. Inside of this cylinder is a second narrower and shorter clear, plastic cylindrical tube that is also secured and sealed to the circular plastic base plate and stands approximately half the height of the outer cylinder. The inlet port to the protein skimmer passes through the bottom of the outer cylinder at the base and connects to the inner cylinder in a location that is offset from the center of the inner cylinder. This will allow the incoming water flow to generate a swirling, rotating motion inside of the inner cylinder causing an increase in mixing action to maximize the interaction between the bubbles and the organic material contained in the aqueous solution. After the water/foam mixture swirls upward and reaches the top of the inner cylinder, the aqueous solution will exit the smaller cross sectional area of the inner cylinder and enter the larger cross sectional area of the outer cylinder. This will effectively reduce the velocity of the moving aqueous solution and allow the foam to separate from the water. With this separation, the foam will continue to move upward inside the outer cylinder until it reaches a higher point in the outer cylinder where the collection cup is located. This collection cup allows the foam to flow out of the protein skimmer and be collected in an external collection vessel. The remaining aqueous solution less the foam will move downward in the space created between the outer and inner cylinders. As the aqueous solution reaches the bottom of the outer cylinder, the water will enter a discharge tube that will exit the side of the outer cylinder, turning upward. This tube continues upward, parallel to the outer cylinder wall to a point above the highest level of the inner cylinder. At this point, the tube will turn 90 degrees before turning perpendicular to the cylinders and moving away to the five-gallon storage containers.

In this experiment, raw wastewater from a pork processing plant is processed using a flocculent with the solid and aqueous components separated from each other until five gallons of aqueous solution is collected. This is placed into the first of the two five-gallon containers. These containers are connected by pipe and hose that, through the manipulation of valves, allows the first container to discharge to the motor/pump assemblage while the second container remains closed. The aqueous solution passes from the first storage container to the motor/pump assemblage that forces the solution under pressure through the venturi tube. As the solution passes through the venturi tube, air is injected into the aqueous stream. This causes the formation of a large amount of small bubbles that begin to attract the organic material contained in the aqueous solution. This water/foam stream moves by hose into the protein skimmer where the foam generated is removed and the aqueous solution continues back to the storage containers. At the input to the storage containers, a pipe and valve system allows for the controlled direction of the returning solution into the second, empty container. Once the first container is empty, the valves are manipulated to close the discharge from the first container, begin drawing solution from the second container, and direct returning solution from the protein skimmer into the now empty first container. At this point, a single cycle is completed with approximately 4 minutes required per cycle.

For COD testing, samples are taken from the storage container prior to start of a test run and then once after each completed cycle. The test run, once started, did not halt until the final cycle was completed; this allowed for the continuous operation of the system. Once all the desired samples were taken, COD levels were determined for each sample utilizing the Hach DR\890 Colorimeter with the Reactor Digestion Method for determining Chemical Oxygen Demand (COD) (Hach Method 8000). Two COD Digestion Reagent Vials were processed for each sample, with the results averaged to determine the recorded COD measurement.

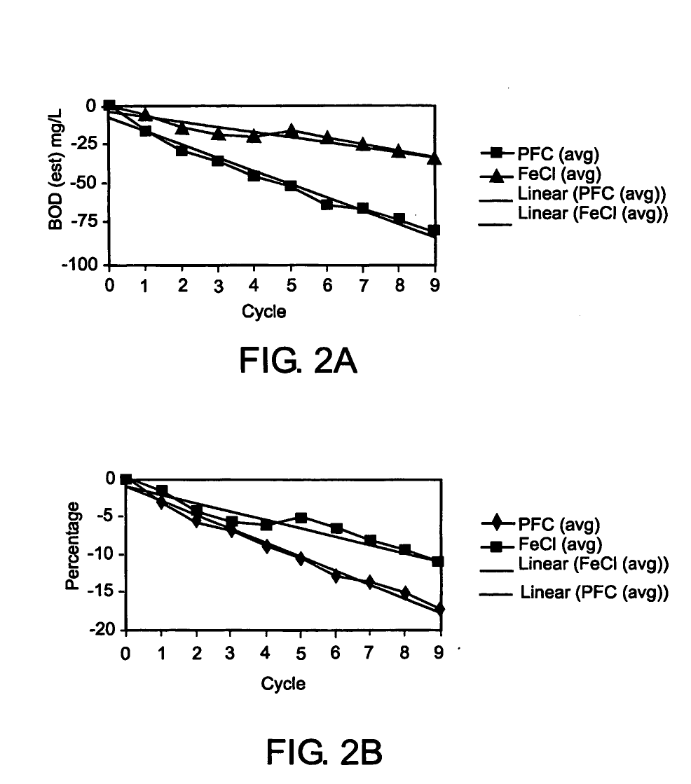

The results, which are shown in graphic form in FIGS. 2A-2B, show a significant improvement in the rate of reduction in recorded BOD (estimated) measurements over 9 cycles utilizing PFC as a flocculent versus using FeCl₃. This improvement is significant both in the reduction in BOD in absolute terms as well as the reduction in BOD as a percentage of the initial BOD levels. Biological Oxygen Demand (BOD) levels are estimated to be 60% of measured COD levels.

1. A method for reducing biological oxygen demand in an aqueous waste stream, wherein said waste stream contains from about 0.02% to about 3.0% magnesium chloride (weight percent) or an equivalent molar amount of divalent magnesium cation, said method comprising the step of aerating the waste stream for a time up to about seven days.

2. The method of claim 1, wherein the step of aerating is from one to seven days.

3. The method of claim 1 or 2, wherein flocculated material is removed prior to the step of aeration.

4. The method of any of claims 1 to 3, wherein the waste stream contains from about 0.02% to about 0.5% MgCl₂ (weight/volume) or an equivalent amount of divalent magnesium cation.

5. The method of any of claims 1 to 4, wherein the step of aerating maintains a dissolved oxygen level from about 1 to about 8 ppm oxygen.

6. The method of claim any of claims 1 to 5, wherein the waste stream is from an animal meat processing facility, from a plant food processing facility, from a fermentation facility or from an organic chemical facility.

7. The method of claim 6, wherein the waste stream is from an animal meat processing facility and wherein a magnesium chloride-dissolved air flotation process has been employed to remove flocculated material, prior to the step of aerating, from the waste stream.

8. The method of any of claims 1 to 7, wherein the step of aerating results in foam formation and wherein the method further comprises the step of foam removal from the waste water.

9. The method of any of claims 1 to 8, wherein the step of aerating is carried out using a Venturi system.
